(19) United States
(12) Patent Application Publication
(10) Pub. No.: US 2019/0127512 A1
(43) Pub. Date: May 2, 2019

(54) POLYMERIZABLE COMPOSITION

(71) Applicant: LANXESS DEUTSCHLAND GMBH, Koln (DE)

(72) Inventors: JOACHIM MORICK, LEVERKUSEN (DE); MICHAEL WITT, ECKERSDORF (DE); DIETER GITTEL, LEVERKUSEN (DE); DOMINIC FUCHS, KOLN (DE); MICHAELA FRANK, LEVERKUSEN (DE)

(73) Assignee: LANXESS DEUTSCHLAND GMBH, Koln (DE)

(21) Appl. No.: 16/094,404

(22) PCT Filed: Mar. 29, 2017
(86) PCT No.: PCT/EP2017/057351

§ 371 Date: Oct. 17, 2018

(30) Foreign Application Priority Data
Apr. 18, 2016 (EP) 16165758.0

(51) Int. Cl. C08G 18/80; C08G 18/38; C08G 18/22; C08K 5/00; C08J 5/24

(52) U.S. Cl. CPC C08G 18/8074; C08G 18/3844; C08J 2375/12; C08K 5/0041; C08J 5/24; C08G 18/225

(57) ABSTRACT

Polymerizable composition comprising
a) at least one cyclic amide,
b) from 1.6 to 5.0% by weight, preferably from 1.8 to 3.5% by weight, of at least one blocked polyisocyanate, and
c) from 0.8 to 2.0% by weight of at least one catalyst for the polymerization of the cyclic amide and
d) from 0.1 to 0.8% by weight, preferably from 0.3 to 0.6% by weight, of the dye C.I. Solvent Black 7,
where the weight data for components a) to d) are based on the entirety of components a) to d), and the entirety of components a) to d) provides 100%.

The present invention relates to a specific polymerizable composition, to a process for the production thereof, and also to use of said composition, and thus to a process for the production of a fiber-reinforced composite material with use of said polymerizable composition.

In a known method for the production of composite plastics composed of a textile reinforcing structure and of a polyamide 6 matrix, and formation of the PA 6 matrix thereof with the aid of in-situ polymerization, a laden, is usually transferred, together with at least one catalyst and at least one activator, into a cavity into which the woven-fabric textile reinforcement has previously been inserted.

The woven fabric here is first impregnated by the low-viscosity monomer melt, and then the system is subjected to anionic polymerization in the mold, whereupon the composite plastics component is produced directly or “in situ”. This type of process is hereinafter termed “reaction injection molding” of polyamide 6, abbreviated to RIM PA 6.

The plastics matrix of RIM PA 6 composite plastics corresponds to traditional “cast PA 6”, in which connection see also P. Wagner, Kunststoffe 73, 10 (1983), pp. 568-590.

The activator is essential in order to reduce the polymerization temperature to a level that makes the polymerization reaction attractive for industrial processes and permits demolding of a composite product within a few minutes.

Materials used as activators for anionic caprolactam polymerization are preferably isocyanates and acyl halides, in particular caprolactam-blocked isocyanates.

For achievement of good mechanical properties in fiber-composite materials, the quality of the coupling between fiber and matrix is important. For this reason, reinforcement fibers are mostly pretreated with what is known as an adhesion-promoting size, in order to provide greater chemical similarity between fibers and surrounding matrix. The sizes applied therefore provide the bonding or the frictional connection to the actual matrix.

The production of fiber-composite materials has already been disclosed in numerous publications: WO2012/045806 and WO2014/086757 describe processes in which in each case a monomer mixture comprising lactam, activator and catalyst is produced in a melt process and then, in a downstream step, is combined with a fiber material to give fiber-composite materials.

Black coloring of the polyamide matrix is desirable for many applications. Conventional black colorings of the type used by way of example in polyamide injection-molding processes are based mainly on carbon black, which can be purchased in various particle sizes. Carbon blacks of this type are marketed as Corax® by Orion Engineered Carbons GmbH, Hahnstrasse 49, 60528 Frankfurt.

However, carbon black particles of this type, preferably in nanoparticle form, have poor suitability for use in RIM PA 6 processes, because the result is nonuniform distribution of the black pigments in the resultant composite plastic. The composite plastic has an inhomogeneous visual appearance, which reduces its value. Furthermore, usual contaminants present in the carbon black often lead to increased content of residual caprolactam monomer in the finished composite plastic.

Although dyes such as azine dyes have also been described for the black dyeing of polyamide melts, for example in DE 10117715, the inventors have found that use before polymerization significantly disrupts the polymerization reaction, this being apparent inter glia from increased residual monomer contents.

### Object

There continues therefore to be a requirement for a solution to the production of a black-colored fiber-reinforced composite material, in particular by way of an RIM PA $ process, where the disadvantages of the processes known from the prior art are avoided and in particular a uniform black coloration of the composite plastic is obtained and at the same time the residual monomer contents, based on the pure PA 6 matrix, are below 1.0% by weight.

### Achievement of Object and Subject Matter of the Invention

Surprisingly, it has now been found that the object can be achieved by using a polymerizable composition comprising
a) at least one cyclic amide,
b) from 1.6 to 5.0% by weight, preferably from 1.8 to 3.5% by weight, of at least one blocked polyisocyanate, and
c) from 0.8 to 2.0% by weight of at least one catalyst for the polymerization of the cyclic amide and
d) from 0.1 to 0.8% by weight, preferably from 0.3 to 0.6% by weight, of the dye C.I. Solvent Black 7,
   where the weight data for components b) to d) are based on the entirety of components a) to d), and the entirety of components a) to d) provides 100%.

It is preferable that the polymerizable composition of the invention comprises from 50 to 100% by weight of components a) to d), preferably from BO to 100% by weight, based on the total weight of the composition. It is particularly preferable that the polymerizable composition of the invention comprises more than 95% by weight of components a) to d), in particular more than 98% by weight.

It is thus possible to produce RIM PA 6 composite plastics with deep black, and especially uniform, coloration which at the same time have low residual monomer contents below 1.0% by weight, based on the polymeric matrix.

### Component a)

Cyclic amide used of component a) is preferably an amide of the general formula (I),

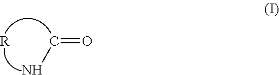

where R is a C₃-C₁₃-alkylene group, in particular a C₅-C₁₁ alkylene group.

Particularly suitable cyclic amides of component a) are lactams of the formula (I) such as ε-caprolactam, 2-piperidone (δ-valerolactam), 2-pyrrolidone (γ-butyrolactam), enantholactam, lauryl lactam, laurolactam or a mixture of these. It is preferable that the cyclic amide of component a) is caprolactam, lauryl lactam or a mixture of these. It is particularly preferable that lactam used is exclusively caprolactam or exclusively lauryl lactam.

### Component b)

The activator of component b) is preferably one based on blocked aliphatic polyisocyanates, for example isophorone diisocyanate (IPDI) or in particular one of the formula OCN—(CH₂)₄₋₂₀—NCO, for example butylene diisocyanate, hexamethylene diisocyanate (HDI), octamethylene dilsocyanate, decamethylene diisocyanate, undecamethylene dilsocyanate or dodecamethylene dilsocyanate. Particular preference is given to blocked hexamethylene diisocyanate (HDI).

Lactam-blocked isocyanate, in particular caprolactam-blocked polyisocyanate, is preferred as blocking agent of the polyisocyanates of component b). It is also possible in principle here to use variously blocked polyisocyanates in a mixture.

Particular preference is given to caprolactam-blocked HDI: N,N′-hexane-1,6-diylbis(hexahydro-2-oxo-1H-azepine-1-carboxamide), CAS No.: 5888-87-9.

The ratio by mass of the cyclic amide of component a) to the blocked polyisocyanate of component b) can vary widely and is generally from 1:1 to 10 000:1, preferably from 5:1 to 2000:1, particularly preferably from 20:1 to 1000:1.

Component c)

The catalyst c) for polymerization of the cyclic amide is preferably selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium hydroxide, potassium methanolate, potassium ethanolate, potassium propanolate and potassium butanolate, preferably from the group consisting of sodium hydride, sodium and sodium caprolactamate, particularly preferably sodium caprolactamate.

The molar ratio of cyclic amide a) to catalyst c) can vary widely, and is generally from 1:1 to 10 000:1, preferably from 5:1 to 1000:1, particularly preferably from 1:1 to 500:1.

### Component d)

The dye C.I. Solvent Black 7 has various CAS numbers, in particular CAS 8005-02-5 and CAS 101357-15-7.

C.I. Solvent Black 7 is also described as reaction product
of the starting materials nitrobenzene, aniline and aniline hydrochloride in the presence of an iron catalyst or copper catalyst, in particular at a temperature of from 180 to 200° C., with subsequent isolation in the form of free base, or
of the starting materials nitrophenol or nitrocresol, aniline and aniline hydrochloride in the presence of a copper catalyst, in particular at a temperature of from 180 to 200° C., with subsequent isolation in the form of free base.

Preferred commercially available C.I. Solvent Black 7 products are the following commercially available substances: Nubian Black® TH 807 and Nubian Black® TN 870 from ORIENT CHEMICAL INDUSTRIES CO., LTD., 7-15, 1-chome Minami-honmachi, Chuo-ku, Osaka, 541-0054, Japan, and NIGROSIN from Lanxess Deutschland GmbH.

The polymerizable composition of the invention can comprise one or more polymers, where the polymer can in principle be selected from polymers which are obtained during the polymerization of the composition that can be polymerized in the invention, polymers differing therefrom, and polymer blends.

In a suitable embodiment, the polymerizable composition of the invention can also comprise filler. Fillers, in particular particulate fillers, can have a wide range of particle sizes, extending from particles in the form of dusts to coarse-grain particles. Filler material that can be used comprises organic or inorganic fillers and/or fiber materials. By way of example, it is possible to use inorganic fillers such as kaolin, chalk, wollastonite, talc, calcium carbonate, silicates, titanium dioxide, zinc oxide, graphite, glass particles, e.g. glass spheres, nanoscale fillers such as carbon nanotubes, carbon black, nanoscale phyllosilicates, nanoscale aluminum oxide (Al₂O₃), nanoscale titanium dioxide (TiO₂), carbon nanotubes, graphene, phyllosilicates and nanoscale silicon dioxide (SiO₂). Although carbon blacks can also be used concomitantly, the proportion thereof is preferably smaller than 1% by weight, in particular smaller than 0.1% by weight.

It is preferable to use a quantity of from 0 to 90% by weight of fillers, based on the polymerizable composition of the invention, in particular from 0 to 50% by weight.

It is moreover possible to use one or more fiber materials. These are preferably selected from known inorganic reinforcement fibers such as boron fibers, glass fibers, carbon fibers, silica fibers, ceramic fibers and basalt fibers; organic reinforcement fibers such as aramid fibers, polyester fibers nylon fibers, polyethylene fibers and natural fibers such as wood fibers, flax fibers, hemp fibers and sisal fibers.

It is particularly preferable to use glass fibers, carbon fibers, aramid fibers, boron fibers or metal fibers. The fibers mentioned are preferably used in the form of continuous fibers, for example in the form of tapes, laid scrims, woven fabrics or knitted fabrics. It is also possible to use an unordered fiber bed, for example in the form of mats, nonwovens, or else chopped fibers of varying fiber length, in particular of length from 0.1 mm to a plurality of cm, preferably length up to 5 cm.

However, it is preferable to delay the use of these fiber materials until the polymerizable composition of the invention is used for the production of the fiber-reinforced composite material of the invention.

In a preferred embodiment, the polymerizable composition of the invention can comprise one or more further additives. Examples of additives that can be added are stabilizers, for example copper salts, dyes, antistatic agents, release agents, antioxidants, light stabilizers, PVC stabilizers, lubricants, blowing agents and combinations thereof. It is preferable to use a quantity of from 0 to 5% by weight of these additives, preferably from 0 to 4% by weight, particularly preferably from 0 to 3.5% by weight, based on the total weight of the polymerizable composition. If flame retardants or impact modifiers are used as additives, the quantity of these additives that can be used is from 0 to 45% by weight, based on the total weight of the polymerizable composition.

The polymerizable composition can comprise at least one additive, the quantity of which is preferably at least 0.01% by weight, based on the total weight of the polymerizable composition, particularly preferably at least 0.1% by weight, based on the total weight of the polymerizable composition, in particular at least 0.5% by weight, based on the total weight of the polymerizable composition.

It is preferable that at least one impact modifier is present as additive in the composition that is polymerizable in the invention. If a polymeric compound is used as impact modifier, this is counted as a constituent of the abovementioned polymers. In particular, a polydiene polymer (e.g. polybutadiene, polyisoprene) is used as impact modifier. These materials preferably comprise anhydride groups and/or epoxy groups. In particular, the glass transition temperature of the polydiene polymer is below 0° C., preferably below −10° C., particularly preferably below −20° C. The polydiene polymer can be based on a polydiene copolymer with polyacrylates, polyethylene acrylates and/or polysiloxanes, and can be produced by the familiar processes (e.g. emulsion polymerization, suspension polymerization, solution polymerization, gas-phase polymerization).

It is preferable that the polymerizable composition is present in the form of its melt. This is preferably the case at its melting point or thereabove, preferably at a temperature above 70° C.

### Production of the Polymerizable Composition

The invention further provides a process for the production of the polymerizable composition, characterized in that a cyclic amide of component a) is brought into contact with at least one blocked polyisocyanate of component b) and with at least one catalyst of component c) and with one dye of component d).

The polymerizable composition is preferably provided by first mixing components b) and c) mutually independently into a), and then mixing these individual mixtures with one another. It is further preferable that the dye d) is added to one or both of the independent preparations of a) and b).

The mixing here can use a solid form of the respective individual components a) and b) and d), and also of a) and c) and d), or can use a liquid, molten form. It is preferable that d) is mixed into a) and b).

The invention likewise provides the resultant activator composition comprising
a) at least one cyclic amide,
b) from 1.6 to 5.0% by weight, preferably from 1.8 to 3.5% by weight, of at least one blocked polyisocyanate, and
d) from 0.1 to 0.8% by weight, preferably from 0.3 to 0.6% by weight, of the dye C.I. Solvent Black 7,
   where the weight data for components b) and d) are based on the entirety of components a) to d).

The activator composition of the invention preferably comprises from 50 to 100% by weight of components a), b) and d), preferably from 80 to 100% by weight, based on the total weight of the activator composition. The activator composition of the invention particularly preferably comprises more than 98% by weight of components a), b) and d), in particular more than 98% by weight.

The activator composition of the invention preferably comprises no catalyst of component c).

The activator mixture of the invention can take the form of solid mixture or else can take the form of melt thereof.

In principle, the same also applies to a catalyst mixture comprising components a), c) and d), where the quantitative data for component c) are from 0.8 to 2.0% by weight of at least one catalyst for the polymerization of the cyclic amide, based on the entirety of a), c) and d), and the other data are analogous to those above for the activator composition.

It is preferable that the separate mixtures prepared above are mixed in liquid form, preferably at a temperature of from 70 to 120° C. The activator here is in particular used in the form of the activator composition of the invention. For the transfer of the liquid mixture phase of components a), b), c) and d) it is preferable to select a temperature that is equal to or higher than the melting point of the resultant mixture.

The components can be mixed batchwise or continuously. Suitable devices for the mixing of the components are known to the person skilled in the art. For the batchwise mixing procedure it is preferable to use kneaders or stirred tanks. Continuous mixing procedures preferably take place in an extruder or an injection-molding machine, or else use static mixing elements incorporated into a mixing head or directly concomitantly incorporated within the tooling. It is also possible to use high-pressure mixing heads which are known from polyurethane processing and in which the mixing is achieved via the kinetic energy of the material.

The mixing device is preferably temperature-controllable. The mixing of the components can by way of example take place continuously in an extruder.

It is also possible that the individual components used for the activators, and also the catalysts used, are ready-to-use commercially available products.

A possible activator of component b) is caprolactam-blocked hexamethylene dilsocyanate in caprolactam, obtainable commercially by way of example as Brüggolen® C20 from Brüggemann or Addonyl® 8120 from Rhein Chemie Rheinau GmbH.

A solution of sodium caprolactamate in caprolactam can be used as catalyst, an example being Brüggolen© C10 from Brüggemann, which comprises from 17 to 19% by weight of sodium caprolactamate in caprolactam, or Addonyl KAT NL from Rhein Chemie Rheinau GmbH, which comprises 18.5% by weight of sodium caprolactamate in caprolactam. Magnesium bromide caprolactamate, e.g. Brüggolen® C1 from Brüggemann, is likewise in particular suitable as catalyst c).

Dye used can be Nubian Black® from ORIENT CHEMICAL INDUSTRIES CO., LTD, Japan, in particular the grades TN 807 and TN 870.

The polymerizable composition is generally handled in the liquid state close to the polymerization temperature, thus having high reactivity, and it is therefore advisable that contact with the fiber reinforcement is achieved without delay.

### Production of a Fiber-Composite Material

The invention further provides a process for the production of a fiber-composite material, characterized in that
i) the polymerizable composition of the invention or individual components a), b), c) and d) thereof is/are brought into contact with fibers and
i) the resulting composition is treated at a temperature of from 120 to 300° C., preferably at from 120 to 250° C., in particular at from 140 to 180° C.

It is preferable that the inventive production of a fiber-composite material is also characterized in that
i) the activator composition of the invention is brought into contact with the individual component c), or in particular with a mixture of components a) and c), and then with fibers, and
ii) the resulting composition is treated at a temperature of from 120 to 300° C.

There are various possible ways here of bringing the fibers into contact with the polymerizable composition,
1) By inserting fibers, in particular textile reinforcement structures, into a heated pressure-tight mold, the temperature of which is preferably from 120 to 170° C., and using superatmospheric pressure to force the polymerizable composition into same, where the fiber is preferably infiltrated and then optionally at an elevated temperature, preferably at from 120 to 300° C., the polymerizable composition polymerizes,
2) By using a setup that is otherwise the same as in 1, applying vacuum at the pressure-tight mold and using suction to draw the polymerizable composition of the invention into same.
3) By using a combination of subatmospheric pressure and superatmospheric pressure as in 1 and 2 to transfer the polymerizable composition into the mold.
4) By carrying out the production process in an extruder, input streams of which comprise fibers, in particular short fibers, and the polymerizable composition, where the extruder is operated at a temperature above the melting point of the polymer resulting from the polymerizable composition, in particular PA 6, PA 12, or the copolymers,
5) By carrying out the production process in an extruder, input streams of which comprise one or more individual components of the polymerizable composition of the invention in solid or liquid form and fibers,
6) By carrying out the process via traditional centrifugal casting, where the polymerizable composition of the invention or individual components a), b), c) and d) thereof are introduced in solid or liquid form and are reinforced with fibers, preferably in the form of short fibers or in the form of textile reinforcement structures.
7) By carrying out the production process continuously via saturation of fibers, in particular of woven fabrics, with polymerization at a temperature of from 120 to 300° C. after application of the polymerizable composition of the invention in liquid form, thus producing composite sheets or organopanels, profiles or tubes made of continuous-fiber-reinforced polyamides.

Preference is given to alternative 1, 2 or 3, where fibers, in particular textile reinforcement structures, are inserted into a heatable, pressure-tight mold. The polymerizable composition is then transferred into the mold by means of a positive gauge pressure of from 1 to 150 bar and/or at a negative gauge pressure of from 10 to 900 mbar in the mold (tooling).

After the mold has been completely filled with the polymerizable, colored composition of the invention, the polymerization reaction takes place at temperatures of from 120 to 250° C., preferably at from 140 to 180° C., The composite component is produced directly in the mold.

Preference is likewise given to the above procedure modified in that a negative gauge pressure is applied at the pressure-tight mold, preferably of from 5 to 800 mbar, and the polymerizable composition is sucked into the mold, and after the polymerizable composition has been charged to the mold the temperature is increased for the polymerization reaction, preferably to a temperature of from 120 to 250° C.

It is also possible to use a combination of subatmospheric pressure and superatmospheric pressure to charge the polymerizable composition to the mold.

It is moreover advantageous to undertake the polymerization in a traditional centrifugal casting process where the polymerizable composition is introduced in solid or liquid form into the mold and the fibers are introduced in the form of short fibers or in the form of previously laid-up textile reinforcement materials.

In the production of the polymerizable composition of the invention, and also in the inventive production of the fiber-reinforced composite materials, it can be advantageous to minimize the proportion of components not involved in the production of the polymerizable composition or of the fiber-reinforced composite material. Among these are specifically water, carbon dioxide and/or oxygen. In a specific embodiment, therefore, the components and apparatuses used are in essence free from water, carbon dioxide and/or oxygen. In a possible method, before the melt is injected, vacuum is first applied to the closed cavity of the tooling. Another option is the use of inert gas, e.g. nitrogen or argon. The polymerizable composition used, and also the fillers or reinforcement materials (fibers, for example textile sheets), can be stored in an inert gas atmosphere and/or blanketed therewith.

### Fibers

Fibers preferably used in the process of the invention are short fibers, long fibers, continuous fibers or a mixture thereof.

For the purposes of the invention, the length of “short fibers” is from 0.1 to 1 mm, the length of “long fibers” is from 1 to 50 mm, and the length of “continuous fibers” is greater than 50 mm. The form in which continuous fibers are used for the production of the fiber-reinforced composite materials is preferably that of a textile structure, e.g. woven fabrics, knitted fabrics, laid scrims or nonwoven fabrics. Components with stretched continuous fibers generally achieve very high values for stiffness and strength.

Fiber material used is preferably made of parallel-arranged continuous yarns or continuous rovings which have been further processed to give textile sheets such as laid scrims, tapes, braids and woven fabrics and the like. Another term used for these sheets is reinforcement structures.

The abovementioned textile sheets can be single- or multiple-ply sheets, and can also be used in various combinations in terms of textile sheets, fiber types and fiber quantities thereof. Preference is given to use of multiaxial laid scrims, other laid scrims, (multiaxial) braids or woven fabrics, where these consist of two or more plies, preferably from 2 to 12.

Fibers present in the fiber materials used are preferably those made of inorganic minerals such as carbon, for example in the form of low-modulus carbon fibers or high-modulus carbon fibers, silicatic and non-silicatic glasses of a very wide variety of types, boron, silicon carbide, metals, metal alloys, metal oxides, metal nitrides, metal carbides, and silicates, and also organic materials such as natural and synthetic polymers, for example polyacrylonitriles, polyesters, polyamides, polyimides, aramids, liquid-crystalline polymers, polyphenylene sulfides, polyetherketones, polyetheretherketones, polyetherimides, cotton, cellulose and other natural fibers, for example flax, sisal, kenaf, hemp, abaca. Preference is given to materials with high melting points, for example glasses, carbon, aramids, liquid-crystalline polymers, polyphenylene sulfides, polyetherketones, polyetheretherketones, and polyetherimides, particular preference being given to glass fibers, carbon fibers, aramid fibers, steel fibers, ceramic fibers and/or other sufficiently heat-resistant polymeric fibers or filaments.

The quantity of fibers that can be used is from 5 to 65% by volume, based on the resultant fiber-composite material, or by way of example when glass fibers are used from 10 to 80% by weight, but is preferably from 45 to 65% by volume, based on the fiber-composite material, particularly preferred fibers here being glass fibers and carbon fibers.

The process of the invention permits very good impregnation of the reinforcement fibers with the colored activated caprolactam melt, uniform coloring of the resultant composite plastic, together with low residual monomer contents, and also economically acceptable polymerization times and formation of products with good mechanical properties.

With the aid of the process of the invention it is possible to produce fiber-reinforced composite materials with a high proportion of fiber and of filler, if the latter is present.

Particular preference is given to the process of the invention when the polymerizable composition or individual components a), b), c) and d) thereof is/are brought into contact with from 5 to 65% by volume of fibers, in particular glass fibers and carbon fibers, based on the resultant fiber-composite material, a preferred quantity being from 45 to 65% by volume.

Particular preference is given to the process of the invention for the production of a fiber-composite material with a proportion of fiber, in particular of glass fiber and of carbon fiber, of from 45 to 65% by volume, where a residual content of monomeric amide a) of at most 1.0% by weight, based on the polymer matrix, is achieved.

### EXAMPLES

200 g of ε-caprolactam and the quantities stated in the tables of catalyst, sodium caprolactamate, CAS No. 2123-24-2 (18.5% by weight in caprolactam, in the form of Addonyl Kat NL (Rhein Chemie Rheinau GmbH)) were weighed into a three-necked flask.

200 g of ε-caprolactam and the quantities likewise specified in the tables of Addonyl 8120 activator, and 1.0% by weight of black colorant of component d) were charged to a second three-necked flask.

Addonyl 8120 is a bilaterally caprolactam-blocked hexamethylene diisocyanate, specifically N,N′-hexane-1,6-diylbis(hexahydro-2-oxo-1H-azepine-1-carboxamide), CAS No.: 5888-87-9.

The contents of the two flasks were melted in oil baths preheated to 120° C. Evacuation was then carried out at this temperature for 10 minutes. Nitrogen was then charged to the two flasks, and the oil baths were removed. Melts were cooled until the temperature of the melts was 110° C.

Laid glass fiber scrims were inserted into a pressure-tight mold (sheet mold) which had previously been controlled to a temperature of 160° C. and had been flushed with N₂, and the cavity was then evacuated (100 mbar).

In the next step, the contents of the feed container are transferred, by virtue of the subatmospheric pressure of 100 mbar, into the cavity of the sheet mold, and polymerized to completion therein. The fiber content by volume was constant in all of the composite sheets produced, and was about 50% by volume. The residual monomer contents of the fiber-composite material were determined by extraction.

Colorants or black colorings obtainable commercially were used, from the following companies:

Nubian Black TH 607 and TN870 from ORIENT CHEMICAL INDUSTRIES CO., LTD, Japan

Corax N 660, N550, N339 carbon black, XPB538 from Orion Engineered Carbons GmbH, Frankfurt

Iron oxide black (Bayferrox®-schwarz, 375) from Lanxess Deutschland GmbH.

### Results in Tabular Form:

TABLE 1
Polymerization formulations used and the residual monomer
contents achieved therewith, and also the homogeneity of
distribution of the black coloration:
Removal of sheet from the mold after 5 minutes (quantities in grams)

| | | | | Homogeneity | |
|---|---|---|---|---|---|
| | | | | of distribution of | |
| | | | | black coloration | |
| | | Addonyl | | on the composite sheet | |
| | | 8120 | Kat NL** | (key to grades: | |
| | Fiber* | % by wt. | % by wt. | see below) | RMC |
| CE 1 | A | 1.69 | 3.21 | 1 | 1.6 |
| CE 2 | A | 1.69 | 3.21 | 1 | 2.5 |
| CE 3 | A | 1.69 | 3.21 | 3 | 1.0 |
| CE 4 | A | 1.69 | 3.21 | 3 | 1.1 |
| CE 5 | A | 1.69 | 3.21 | 3 | 0.9 |
| CE 6 | A | 1.69 | 3.21 | 5 | 1.0 |
| CE 7 | A | 1.69 | 3.21 | 5 | 1.0 |

*Reinforcement A: Woven glass fiber fabric from Interglas, type 92125 with weight per unit area 280 g/m². The fiber here has a commercially available unreactive size appropriate for polyamide. 9 plies of the woven fabric were inserted into the cavity of the sheet mold in each case.
**Proportion of catalyst per se: 0.59% by weight, based on the matrix.

### Abbreviations

CE: Comparative example
   CE 1: Nubian Black TH807
   CE 2: Nubian Black TN870
   CE 3: Corax N339
   CE 4: Corax N550
   CE 5: Corax N660
   CE 6: Bayferrox®-schwarz 375
   CE 7: Carbon Black XPB538
Assessment of homogeneity: 1: Completely uniform distribution
   3: Significant differences in coloration discernible
   5: Extreme differences in coloration
RMC: Residual monomer content, based on the polymer matrix

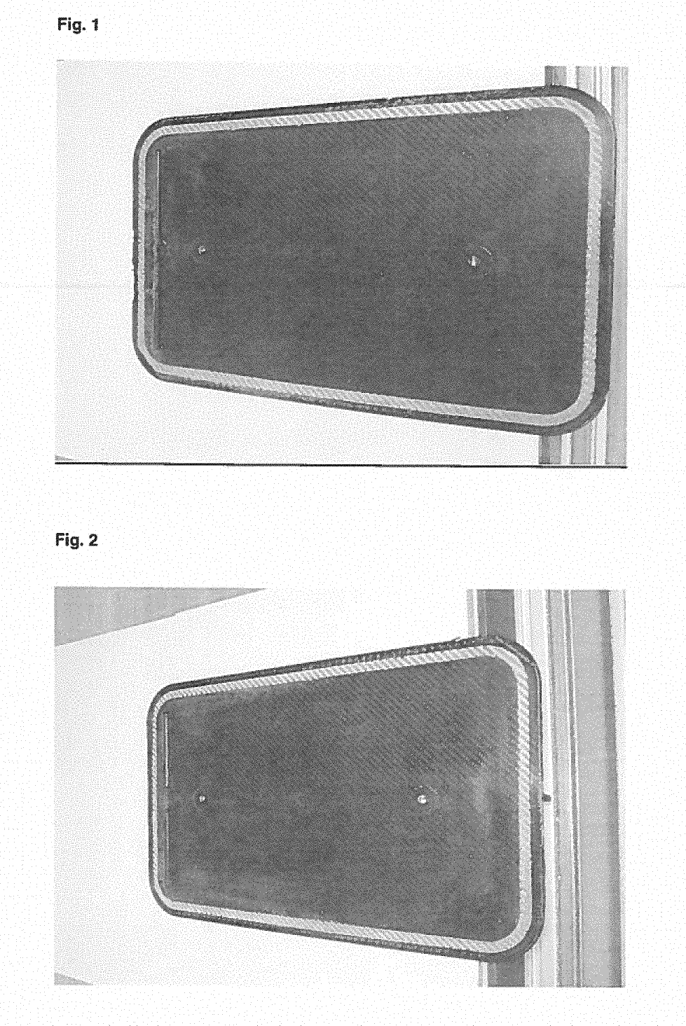

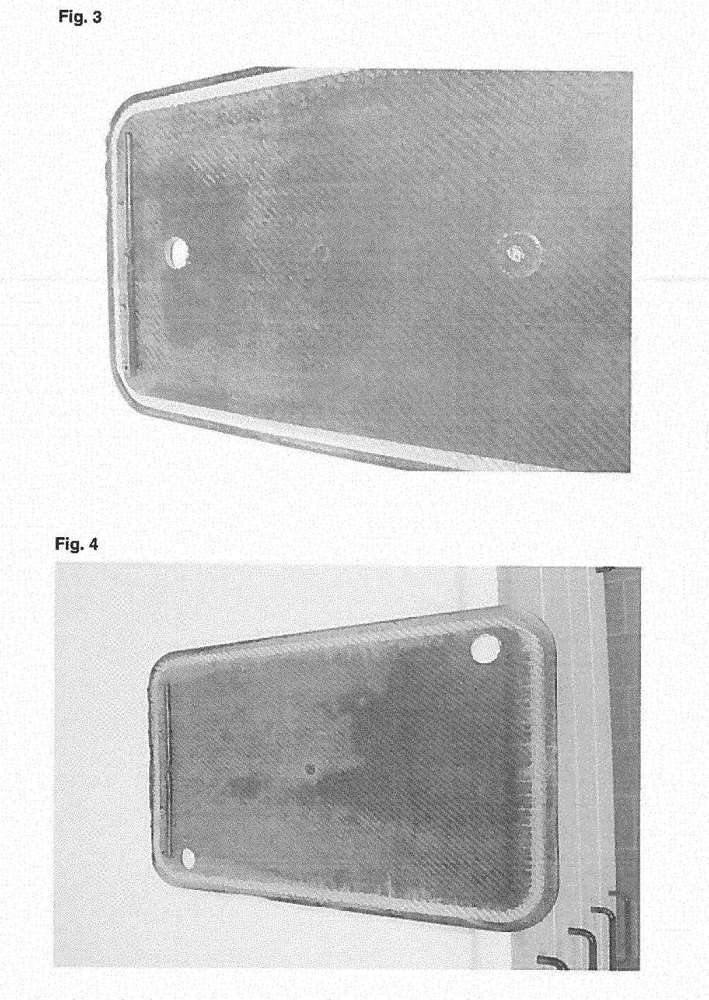

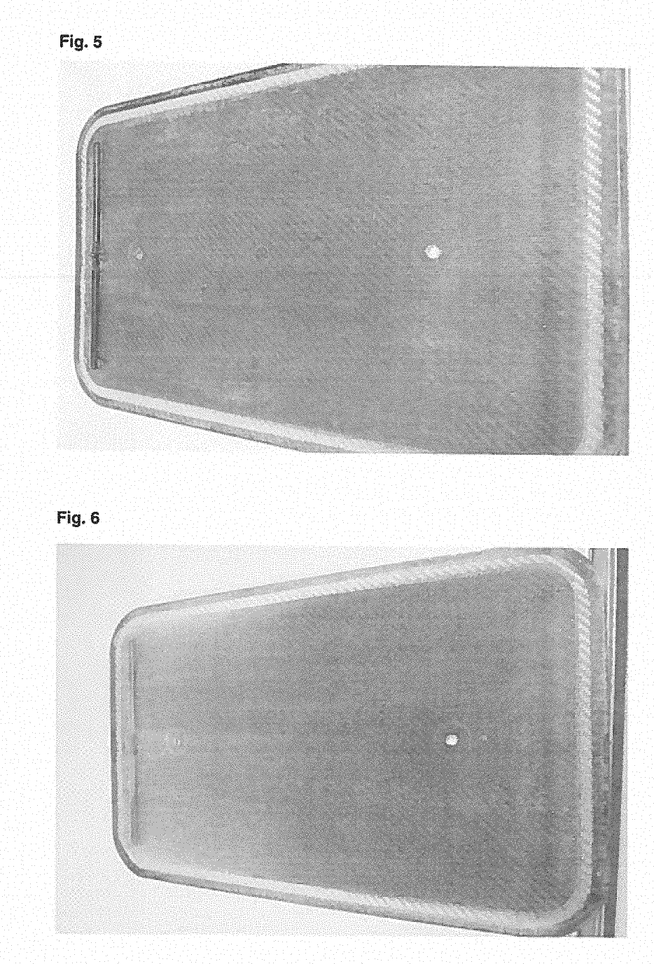

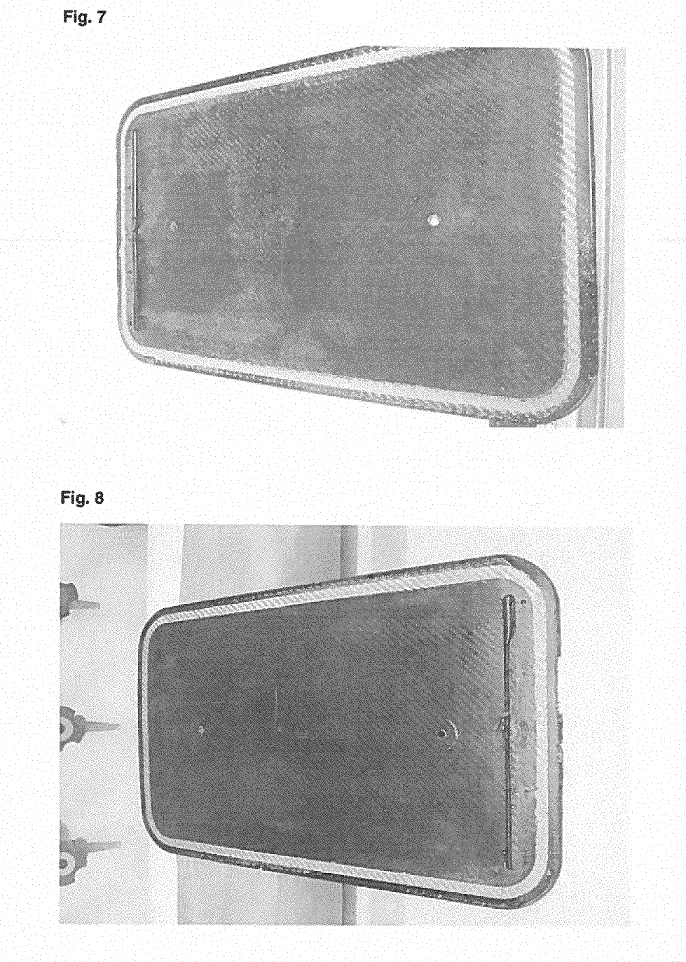

FIG. 1 to FIG. 7 show photographs of the colored composite sheets for visualization of the black coloring in a sequence corresponding to the listing in table 1.

TABLE 2
Polymerization formulations used and the residual monomer contents
achieved therewith, and also the quality of distribution and the
appearance of the black coloration:
Removal of sheet from the mold after 5 minutes (quantities in grams)

| | | | | Homogeneity of | |
|---|---|---|---|---|---|
| | | | | distribution of | |
| | | | | black coloration on | |
| | | Addonyl | | the composite sheet | |
| | | 8120 | Kat NL** | (key to grades: | |
| | Fiber* | % by wt. | % by wt. | see below) | RMC |
| Inv 1 | A | 2.0 | 6.0 | 1 | 0.7 |
| Inv 2 | A | 2.0 | 6.0 | 1 | 0.8 |
| CE 8 | A | 2.0 | 6.0 | 3 | 0.9 |
| CE 9 | A | 2.0 | 6.0 | 3 | 0.9 |
| CE 10 | A | 2.0 | 6.0 | 3 | 0.8 |
| CE 11 | A | 2.0 | 6.0 | 5 | 0.9 |
| CE 12 | A | 2.0 | 6.0 | 5 | 0.8 |

**Reinforcement A: Woven glass fiber fabric from Interglas, type 92125 with weight per unit area 280 g/m². The fiber here has a commercially available unreactive size appropriate for polyamide. 9 plies of the woven fabric were inserted into the cavity of the sheet mold in each case.
**Proportion of catalyst per se: 1.11% by weight, based on the matrix.

### Abbreviations

CE: Comparative example
Inv: Inventive
   Inv 1: Inventive, Nubian Black TH807
   Inv 2: Inventive, Nubian Black TN870
   CE 8: Corax N339
   CE 9: Corax N550
   CE 10: Corax N660
   CE 11: Bayferrox®-schwarz 375
   CE 12: Carbon Black PB 38
Assessment of homogeneity: 1: Completely uniform distribution
   3: Significant differences in coloration discernible
   5: Extreme differences in coloration
RMC: Residual monomer content, based on the polymer matrix

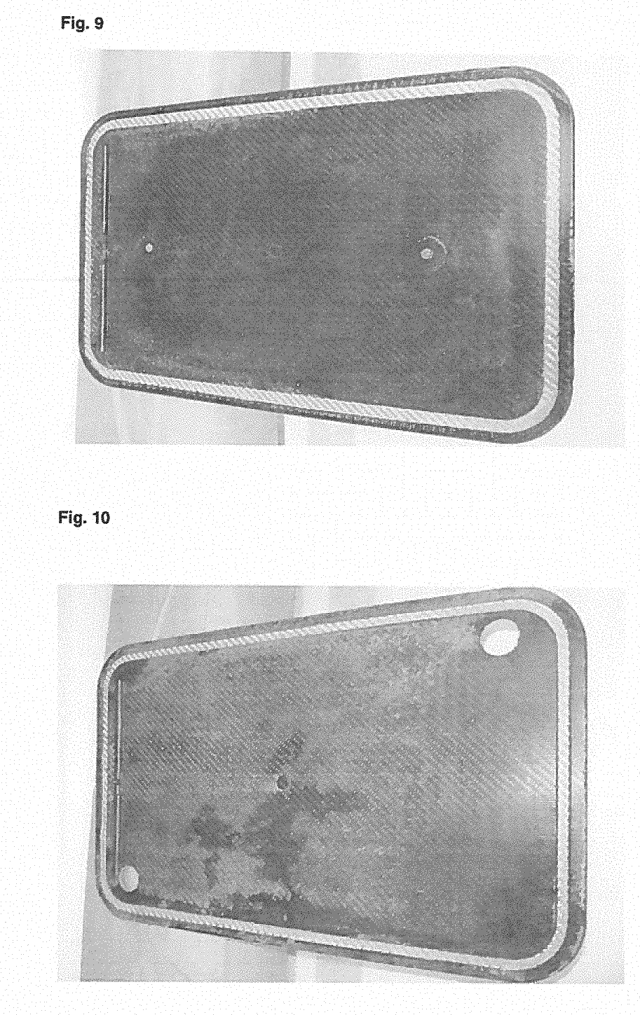

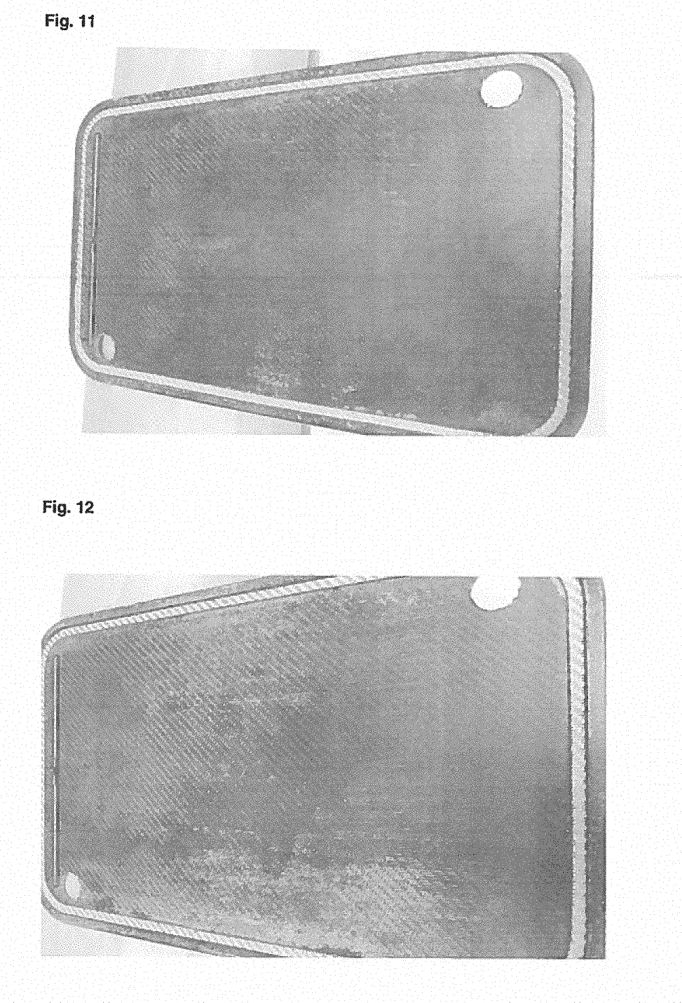

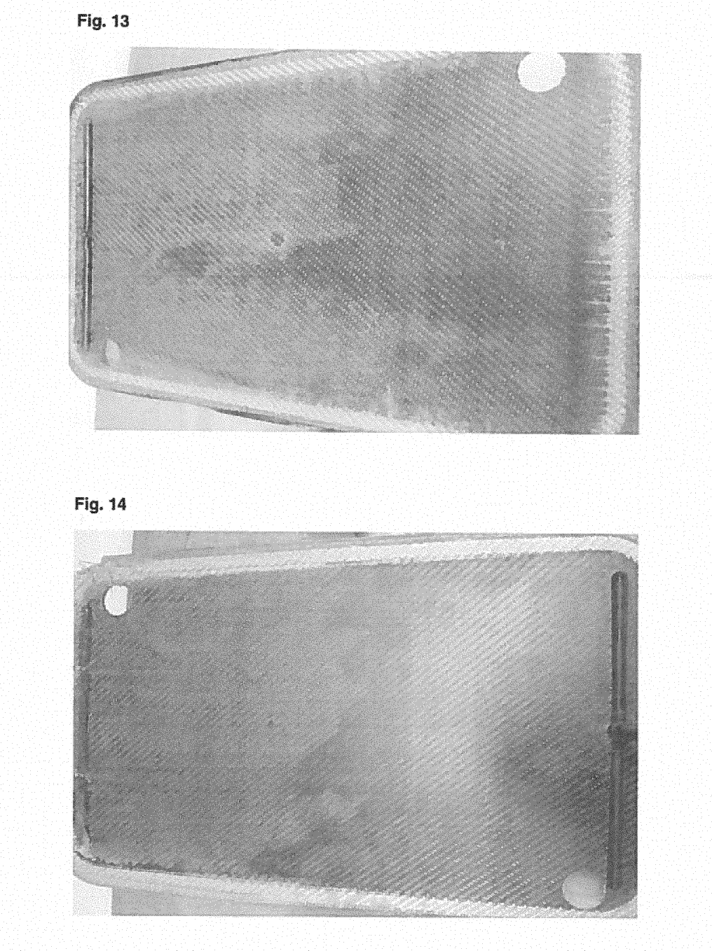

FIG. 8 to FIG. 14 show photographs of the colored composite sheets for visualization of the black coloring in a sequence corresponding to the listing in table 2 (where Inv 1=FIG. 8, Inv 2=FIG. 9 . . . ).

1. A polymerizable composition comprising,
a) at least one cyclic amide,
b) 1.6 to 5.0% by weight of at least one blocked polyisocyanate,
c) 0.8 to 2.0% by weight of at least one catalyst for the polymerization of the cyclic amide, and
d) 0.1 to 0.8% by weight of dye C.I. Solvent Black 7,
where the weight data for components b) to d) are based on the entirety of components a) to d).

2. The polymerizable composition as claimed in claim 1, wherein the cyclic amide corresponds to the general formula (I), 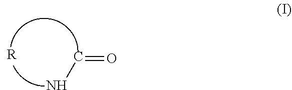
where R is a C₃-C₁₃-alkylene group.

3. The polymerizable composition as claimed in claim 1, wherein the cyclic amide is lauryl lactam, caprolactam or a mixture of these.

4. The polymerizable composition as claimed in claim 1, wherein the blocked polyisocyanate comprises at least one of isophorene dilsocyanate (IPDI), butylene diisocyanate, hexamethylene diisocyanate (HDI), octamethylene diisocyanate, decamethylene diisocyanate, undecamethylene diisocyanate, and dodecamethylene diisocyanate.

5. The polymerizable composition as claimed in claim 1, wherein the at least one catalyst is selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium hydroxide, potassium methanolate, potassium ethanolate, potassium propanolate and potassium butanolate, preferably from the group consisting of sodium hydride, sodium and sodium caprolactamate, particularly preferably sodium caprolactamate.

6. The polymerizable composition as claimed in claim 1, wherein the composition is composed of more than 95% by weight of components a) to d), in particular more than 98% by weight.

7. A process for the production of the polymerizable composition as claimed in claim 1, the process comprising contacting the cyclic amide with the at least one blocked polyisocyanate, the at least one catalyst, and the at least one dye.

8. An activator composition comprising:
a) at least one cyclic amide,
b) 1.6 to 5.0% by weight of at least one blocked polyisocyanate, and
d) 0.1 to 0.8% by weight of dye C.I. Solvent Black 7,
where the weight data for components b) to d) are based on the entirety of components a), b) and d).

9. The activator composition as claimed in claim 8, wherein the composition is composed of more than 95% by weight of components a), b) and d), in particular more than 98% by weight.

10. A process for the production of a fiber-composite material, the process comprising:
i) contacting the polymerizable composition as claimed in claim 1 or one or more individual components a), b), c) and d) thereof with fibers, and
i) treating the resulting composition at a temperature of 120 to 300° C.

11. The process for the production of a fiber-composite material as claimed in claim 10, wherein
i) the contacting comprises:
premixing the at least one cyclic amide, the at least one blocked polyisocyanate, and the dye to form an activator composition,
contacting the activator composition with at least the individual component c) to produce the polymerizable composition, and
then contacting the polymerizable composition with the fibers, and
ii) treating the resulting composition at a temperature of 120 to 300° C.

12. The process as claimed in claim 10, wherein the polymerizable composition, or individual components a), b), c) and d) thereof, is/are brought into contact with 5 to 65% by volume of the fibers, based on the fiber-composite material, preferably from 45 to 65% by volume.

13. The process as claimed in claim 10, wherein the fibers comprise glass fibers.

14. The polymerizable composition according to claim 1, wherein the composition comprises:
a) the at least one cyclic amide,
b) 1.8 to 3.5% by weight of the at least one blocked polyisocyanate,
c) 0.8 to 2.0% by weight of the at least one catalyst, and
d) 0.3 to 0.6% by weight of the dye,
where the weight data for components b) to d) are based on the entirety of components a) to d), and the entirety of components a) to d) provides 100%.

15. The polymerizable composition as claimed in claim 14, wherein:
the cyclic amide corresponds to compounds of the general formula (I), 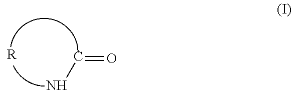
where R is a C₅-C₁₁-alkylene group;
the blocked polyisocyanate is selected from the group consisting of isophorone diisocyanate (IPDI), butylene diisocyanate, hexamethylene diisocyanate (HDI), octamethylene diisocyanate, decamethylene diisocyanate, undecamethylene diisocyanate, and dodecamethylene diisocyanate; and
the at least one catalyst is selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium hydroxide, potassium methanolate, potassium ethanolate, potassium propanolate and potassium butanolate.

16. The polymerizable composition as claimed in claim 15, wherein:
the cyclic amide is lauryl lactam, caprolactam or a mixture of these; and
the blocked polyisocyanate is hexamethylene diisocyanate (HDI); and
the catalyst is sodium caprolactamate.
